(19) United States
(12) Patent Application Publication
(10) Pub. No.: US 2011/0133691 A1
(43) Pub. Date: Jun. 9, 2011

(54) Wireless Galvanic Charging Device,Method of Operation Thereof and Mobile Electric Device to be Charged

(75) Inventor: Jukka Olavi Hautanen, Tampere (FI)

(73) Assignee: NOKIA CORPORATION, Espoo (FI)

(21) Appl. No.: 12/743,779

(22) PCT Filed: Nov. 20, 2007
(86) PCT No.: PCT/EP07/10004

§ 371 Date: Nov. 15, 2010

(51) Int. Cl. H02J 7/00

(52) U.S. Cl. 320/108; 320/107

(57) ABSTRACT

A wireless charging device (35) for charging a battery of a mobile electronic device (1). The charging device (35) includes a wireless receiver (39) and a plurality of electrodes (44, 45) that are connected to a power source. The power source is controlled by a controller (40) that is coupled to the wireless receiver (39). Whilst the wireless receiver (39) receives a wireless signal that is associated with a compatible mobile device (1) the controller (40) instructs the power source to power the electrodes (44, 45). Alternatively, the wireless signal can be indicative of the need of the mobile device (1) to be charged and the controller (40) will only power the electrodes (44, 45) if a signal indicating that the mobile device (1) needs to be charged is received. A mobile battery operated device (1) that sends an indicating signal when the battery of the device needs to be charged.

### FIELD OF THE INVENTION

The present invention relates to charging devices for mobile battery operated devices, in particular to charging devices for wireless charging of a battery in an external mobile device. Further, the invention relates to a method of charging a battery in a mobile electronic device.

### BACKGROUND OF THE INVENTION

Conventional charging devices are provided with a cradle with galvanic contacts or with a wired connector with galvanic contacts to create electrical contact with a mobile device to be charged. Various problems are associated with these types of charging devices.

One of the problems is that the electrodes are always powered when the charging device is on, which leads to unnecessary energy consumption. Given the enormous amount of charging devices that are in use on the whole planet this constitutes a substantial waste of energy.

Another of the problem is that conventional charges require an exact placement or alignment of the galvanic contacts on the device to be charged with the galvanic contacts of the charging device.

WO 2007/099412 discloses a charging devices that operate with a matrix of electrodes on a charging pad that collaborates with a similar charging pad on the device to be charged. The charging pads include galvanic contacts and the pads are in operation brought into contact with one another. The system comprises a charging pad with a first array of contact pads separated from one another by a minimum first device contact pad separation distance. Adjacent contact pads form different terminals of the electrical circuit, and diagonal pads are electrically connected to one another. A mobile device comprises a second array of mobile device contact pads. The separation between adjacent mobile device contact pads is less than the smallest dimension of the first device contact pads through a centre point thereof. The footprint of the mobile device contact pads have a largest dimension smaller than the minimum first device contact pad separation distance. Thus each of the adjacent first device contact pads contacts with a different one of the mobile device contact pads, thereby to include the mobile device in the electrical circuit. This can be used for charging and/or data transfer. Any orientation of the mobile device results in an electrical circuit with the charging pad. However, short circuiting problems and incompatibility issues are associated with this type of charging devices.

### DISCLOSURE OF THE INVENTION

On this background, it is an object of the present invention to provide a charging device that overcomes or at least reduces the problems indicated above.

This object is achieved in one way by providing a charging device comprising a plurality of electrodes on a charging surface, a wireless receiver or transceiver configured to receive a wireless signal from a mobile device to be charged, a power source connected to the electrodes, and a controller coupled to the wireless receiver and to the power source, the controller being configured to control the power to the electrodes in response to a wireless signal received from the mobile device to be charged.

By providing a charging device that is waiting for a wireless signal from the mobile device to be charged unnecessary activation of the electrodes can be avoided and thus unnecessary energy consumption can be avoided.

Preferably, controller is configured to depower the electrodes as a default to even further reduce the energy consumption of the charging device.

The controller may be configured to determine on the basis of the wireless signal if the mobile device is of a type that can be charged with the charging device. Thus, any incompatible mobile devices will not be inadvertently charged in incorrect manner.

The controller may be configured to power the electrodes whilst a wireless signal is received that is associated with a mobile device that can be charged with the charging device.

The controller may be configured to depower the electrodes when the signal that is associated with a mobile device that can be charged with the charging device is no longer received so that the electrodes are only powered when the wireless signal is received and the electrodes are deep powered when no such wireless signal is received.

Identification of the mobile device may be realized with near field RFID.

The controller may be configured to determine from the wireless signal received from the mobile device to the charged if the mobile device needs to be charged so that the electrodes are only powered if the mobile device has indeed a need to be charged.

The control may be configured to power the electrodes whilst it receives a signal indicating that the mobile device needs to be charged that the electrodes will not be powered when no such signal is received.

The control may be configured to depower the electrodes when the signal indicating that the mobile device needs to be charged is no longer received.

The object above can also be achieved in another way by providing a mobile electronic device powered by a rechargeable battery, the mobile device comprising a wireless transmitter or transponder, a controller configured to instruct the transmitter or transponder to transmit a wireless signal indicative that the mobile device requires charging when the controller has determined that the battery needs to be charged.

The object above can also be achieved in yet another way by providing a mobile electronic device powered by a rechargeable battery, the mobile device comprising a wireless transmitter or transponder that is configured to transmit a signal indicating the compatibility of the mobile device with charging devices.

Preferably, the transmitter or transponder is a short range device.

The object above can also be achieved by providing a method for operating a charging device for charging mobile battery operated devices, the method comprising receiving a wireless signal from the mobile battery operated device identifying the mobile device, determining if the received wireless signal identifies a mobile device that is compatible with the charging device, and activating charging electrodes of the charging device whilst a wireless signal is received from a mobile battery operated device that is compatible with the charging device.

The object above can also be achieved by providing charging device comprising a multitude of positive and negative electrodes on a charging surface, a power source connected to the electrodes, and the power source being configured to reduce electric power any electrodes that are short circuited.

Thus, if a short circuit occurs the charging device will emit the short-circuit current to the specific electrode for electrodes. However, the other electrodes and will operate normally.

Preferably, the electrodes are arranged in an array on the charging surface. The array may be a matrix.

The array may be rectangular matrix with alternating positive and negative electrodes.

Each of the positive electrodes may be connected to the power source via positive temperature coefficient resistor so that current to the positive electrodes is automatically limited when a short circuit occurs.

The object above is achieved in another way by providing method for operating a charging device that comprises a multitude of electrodes on a charging surface, the method comprising powering the electrodes, detecting any electrodes that are short circuited, and reducing power to the electrodes that have been detected as being part of a short circuit.

Preferably, the current to the positive contact electrodes that have been identified as being part of a short circuit is reduced.

Further objects, features, advantages and properties of the mobile battery charging device and method of according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 is an elevated view of a charging device according to an embodiment of the invention with a mobile device to be charged according to an embodiment of the invention placed on the charging device,

FIG. 2 is a top view on a charging pad of the charging device according to FIG. 1,

FIG. 3 is a diagram of a charging pad and charging circuit of the mobile device shown in FIG. 1,

FIG. 4 illustrates the operation of the charging pad with several mobile devices to be charged,

FIG. 5 shows a detail of the charging circuit of the charging device shown in FIG. 1,

FIG. 6 is a block diagram illustrating the general architecture of a charging device according to an embodiment of the invention and of a mobile device to be charged according to embodiment of the invention,

FIG. 7 is a block diagram illustrating the general architecture of a charging device according to another embodiment of the invention and of a mobile device to be charged according to another embodiment of the invention, and

FIG. 8 is a block diagram illustrating the general architecture of a charging device according to an embodiment of the invention and of a mobile device to be charged according to embodiment of the invention.

### DETAILED DESCRIPTION OF PREFERRED EMBODIMENTS

In the following detailed description, the charging device according to the invention will be described by the preferred embodiments. The mobile device containing a battery to be charged will also be described.

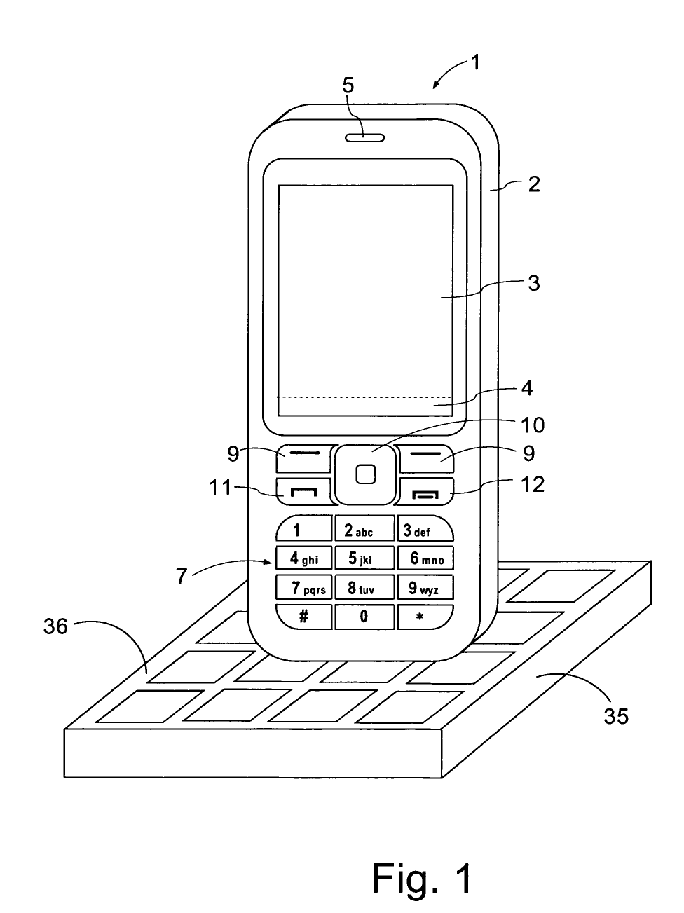

FIG. 1 illustrates a charging device 35 in the form of a charging pad. The charging device 35 has a housing that is provided with a charging pad 36 of its top surface. The charging pad is provided with a matrix of positive and negative electrodes. The charging device 35 can be connected to a mains socket 50 (A/C, typically 110 or 240 V) by a cable and plug (not shown).

The mobile phone 1 comprises a user interface having a housing 2, a display 3, an on/off button (not shown), a speaker 5 (only the opening is shown), and a microphone 6 (not visible in FIG. 1). The phone 1 according to the first preferred embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

The keypad 7 has a first group of keys as alphanumeric keys. The keypad 2 has additionally a second group of keys comprising two softkeys 9, two call handling keys (offhook key 11 and onhook key 12), and a 5-way navigation key 10. A releasable rear cover (not shown) gives access to the SIM card (not shown), and a rechargeable battery 24 (cf. FIG. 3) in the back of the mobile phone that supplies electrical power for the electronic components of the mobile phone 1.

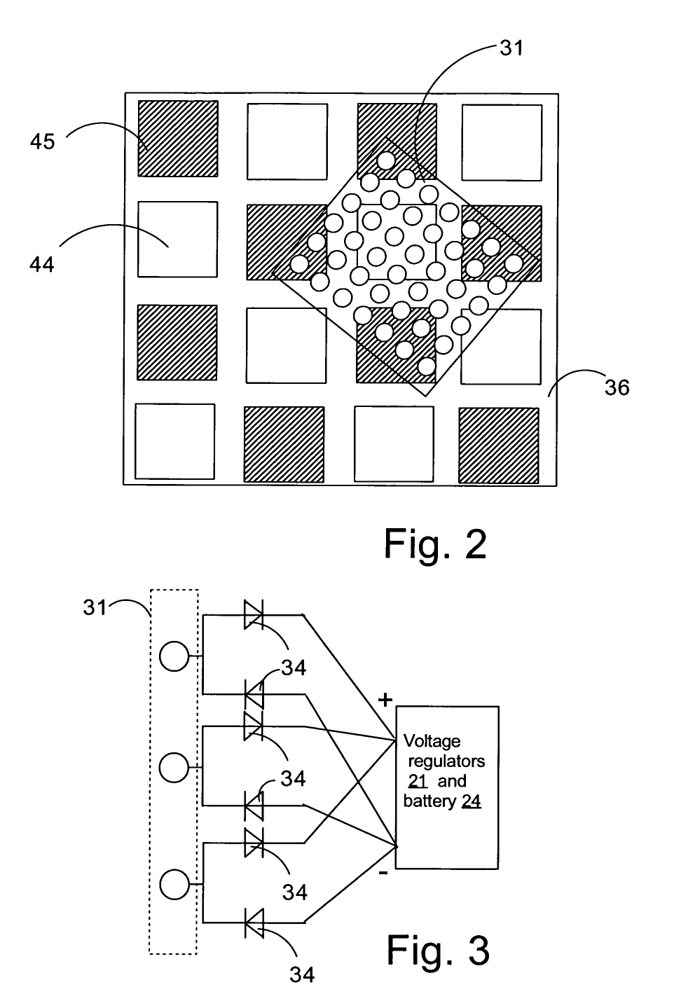

The mobile phone 1 is provided with a charging pad 31 (see FIG. 2) for interaction with the charging pad 36 of the charging device. Such a charging pad assembly is known from WO 2007/099412,

The charging pad 36 of the charging device 35 and the charging pad 31 of the mobile phone 1 will now be described in greater detail with reference to FIG. 2.

The charging pad 36 of the charging device 35 comprises a matrix of alternating negative electrodes 44 and positive electrodes 45. The electrodes 44,45 are in the form of contact pads in a matrix of four by four pads, although a different number of charging pads contact pads may be used instead. The electrodes on both charging pads 31,36 are galvanic contacts and are coated with a material having sufficiently high electrical conductivity, for instance copper, silver, a silver-cadmium alloy and/or gold. The positive 45 electrodes are indicated by hatching. The contacts 44,45 may be arranged in array different from a matrix or rectangular matrix.

The charging pad 31 on the mobile phone 1 is smaller than the charging pad 36 of the charging device and is provided with a matrix of galvanic contacts that are spaced much closer and are smaller than on the charging pad 36 of the charging device 35. The charging pad 31 is provided at the bottom of the mobile phone 1.

The distance between the electrodes 44,45 on the charging pad 36 is such that any of the relatively small electrodes on the charging pad 31 will not be able to get into contact with more than one of the electrodes 44 4,45 on the charging pad 36. This avoids the possibility of inadvertently providing a short circuit.

In operation, the mobile device (mobile phone) 1 is simply placed on top of the charging device 35 so that the electrodes of the respective devices get into contact with one another.

As illustrated in FIG. 3, each of the electrodes on the charging pad 31 of the mobile phone is connected to the voltage regulators 21 and the thereby to the battery 24 of the mobile phone via two conduits, that connect to the positive and negative terminal of the voltage regulators 21, respectively. Each of the two conduits is provided with a diode 34, and the diodes 34 are arranged such that current can only flow towards or from the respective terminals on the voltage regulators 21 in the correct direction. Thus, regardless whether a contact on the charging pad 31 of the mobile device 1 gets into contact with a negative contact 44 or a positive contact 45 of the charging pad 36 of the charging device 35, the current will always flow in the correct direction.

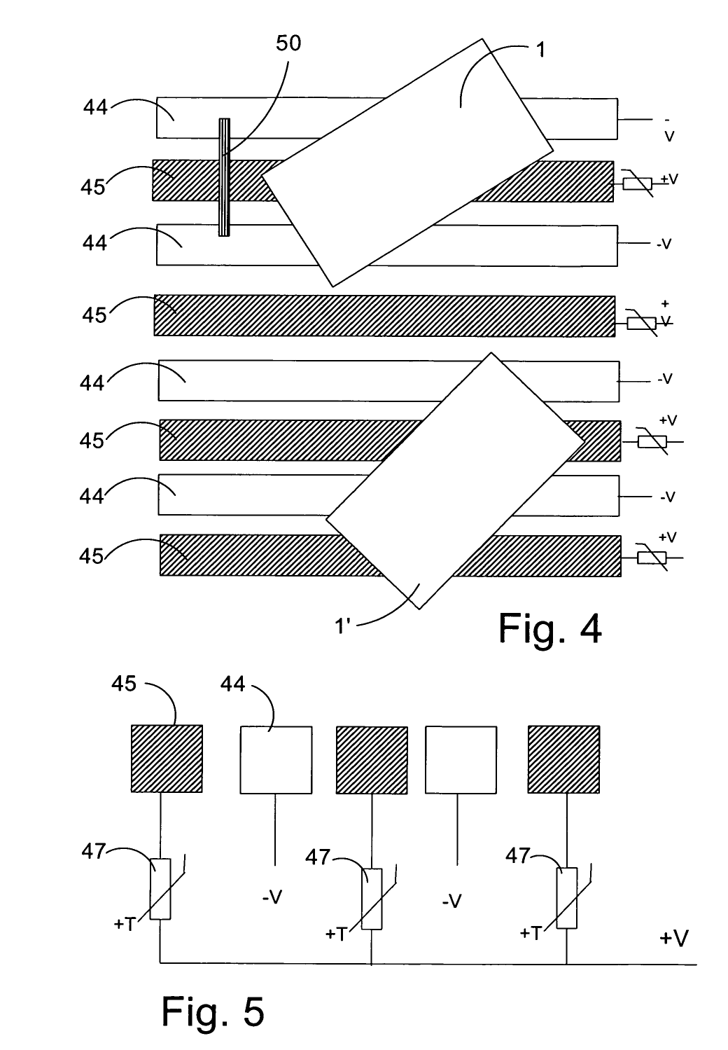

FIG. 4 illustrates another embodiment of the charging device 35 in which the charging pad consists of galvanic contacts that are formed by strips of conductive material. This figure also illustrates how more than one mobile device to be charged can be placed on the charging pad; in this case a first mobile device 1 and a second mobile device 1′. The first mobile device 1 has caused a shortcut illustrated by the imaginary connection 50. In this embodiment the charging device 35 is provided with a shortcut protection system that allows the nonaffected electrodes to remain powered. This protection system is illustrated in FIGS. 4 and 5 and includes in this embodiment a positive thermal coefficient transistor 47 (PTC transistor) in each of the conduits that connects the respective positive electrodes 45 to the positive terminal of the power supply.

If shortcut occurs the short-circuit current to the affected positive electrode and 45 is limited by the respective PTC transistor 47. However, the other electrodes of the charging pad 36 will operate normally.

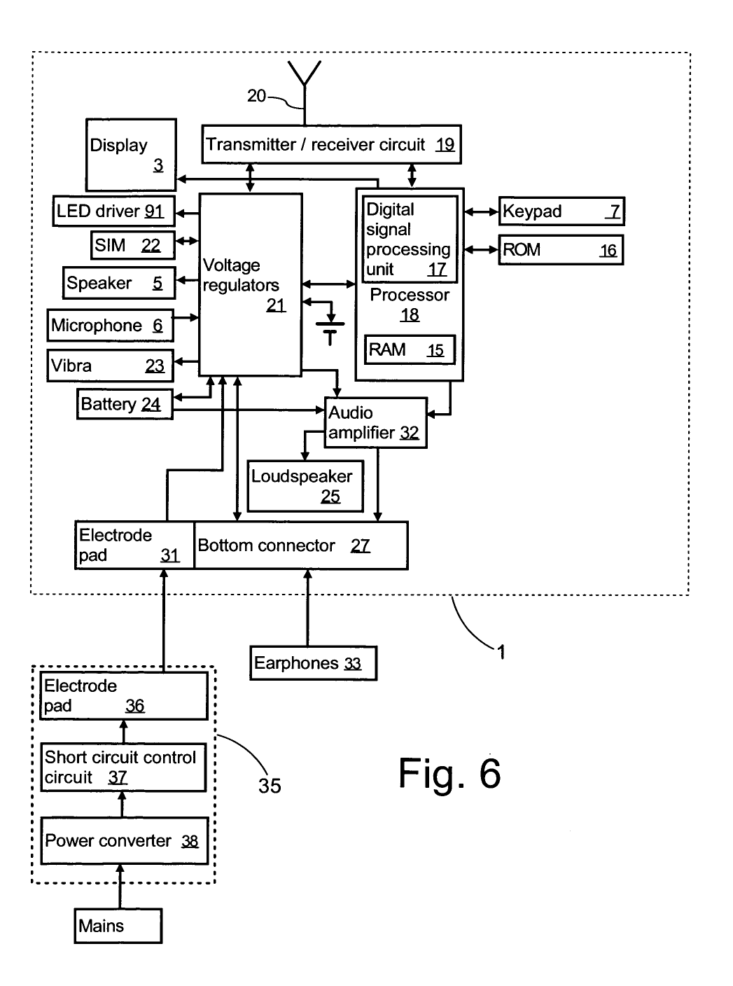

FIG. 6 illustrates in block diagram form the general architecture of an embodiment of the charging device 35 and of the mobile phone 1.

In the mobile phone the processor 18 controls the operation of the terminal and has an integrated digital signal processor 17 and an integrated RAM 15. The processor 18 controls the communication with the cellular network via the transmitter/receiver circuit 19 and an internal antenna 20. A microphone 6 coupled to the processor 18 via voltage regulators 21 transforms the user's speech into analogue signals, the analogue signals formed thereby are A/D converted in an A/D converter (not shown) before the speech is encoded in the DSP 17 that is included in the processor 18. The encoded speech signal is transferred to the processor 18, which e.g. supports the GSM terminal software. The digital signal-processing unit 17 speech-decodes the signal, which is transferred from the processor 18 to the speaker 5 via a D/A converter (not shown).

The voltage regulators 21 form the interface for the speaker 5, the microphone 6, the LED drivers 91 (for the LEDS backlighting the keypad 7 and the display 3), the SIM card 22, battery 24, the bottom connector 27, the charging pad 31 (for establishing an electrical connection to the charging pad 36 of the charging device 35) and the audio amplifier 32 that drives the (hands-free) loudspeaker 25.

The processor 18 also forms the interface for some of the peripheral units of the device, including a (Flash) ROM memory 16, the graphical display 3 and the keypad 7.

The charging device 35 includes a power converter 38 that is can be connected to the mains via a cable and plug (is not shown). The power converter 38 transforms A/C power from the mains into lower voltage D/C power at its outlet. The outlet of the power converter 35 is connected to a short-circuit control circuit 37. The short-circuit control circuit can for example be of the type as illustrated in FIG. 5. However, other types of short-circuit control circuits can be used. When the electrical connection between the electrode pad 36 and the electrode pad 31 has been established DC current is fed to the battery 24 of the mobile device. The voltage regulators in the mobile phone 1 include the charging circuitry and control the charging process.

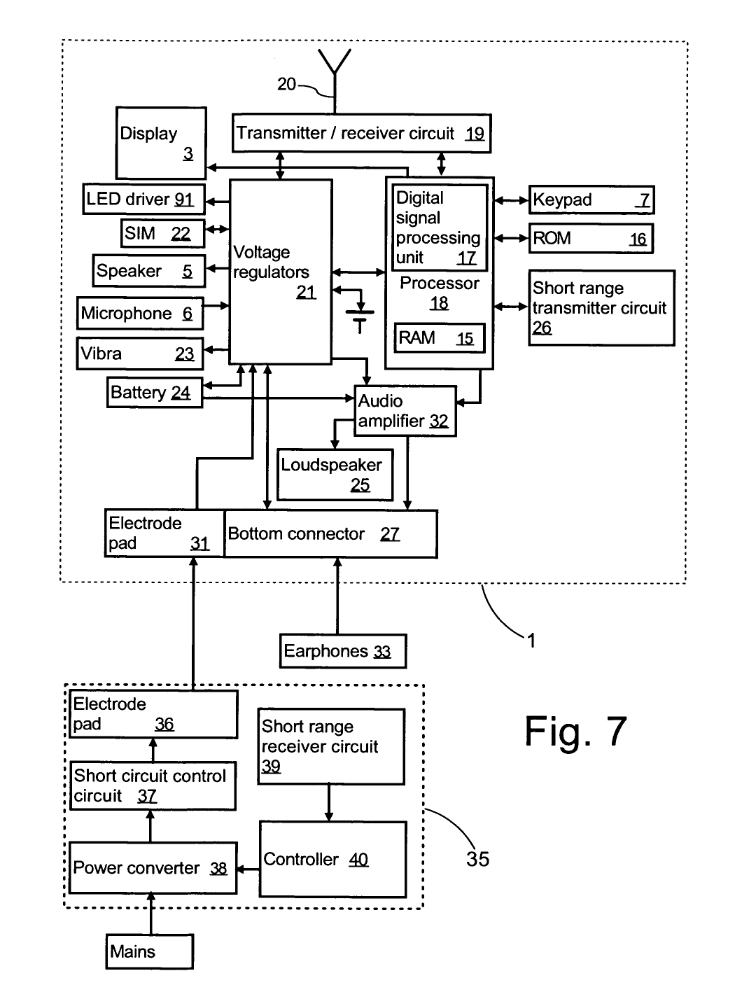

FIG. 7 illustrates another embodiment of the invention that is essentially identical to the embodiment described above. However, in the embodiment of FIG. 7 the mobile phone 1 is additionally provided with a short range transmitter circuit 26 and the charging device 35 is additionally provided with a short range receiver circuit 39. The short range transmitter circuit 26 is connected to the processor 18 of the mobile phone and transmits a short range signal that identifies the mobile phone 1, in particular it identifies the type of mobile phone or other mobile device.

Further, the charging device 35 is provided with a short range receiver circuit 39 that is coupled to a controller 40 which in turn is coupled to the power converter 38. The short range receiver circuit 39 is able to receive the short range signal that contains the identification information of the mobile device 1 when the mobile device is very near to the charging device 35. The short range transmitter circuit 26 and the short range receiver circuit 39 are configured such that the short range signal will only be received by the short range receiver circuit when the mobile device 1 is placed on the charging device 35.

The short range receiver circuit 39 transmits the information of the received signal to the controller 40. The controller 40 determines whether the information in the received signal identifies a mobile device that is compatible with the charging device 35, i.e. can be charged with the charging device 35. The determination of the compatibility may be performed by the controller 40 on the basis of a lookup table or the like. When there is no compatibility, the controller 40 will not power the electrodes on the electrode pad 36. When there is compatibility the controller 40 will power the electrodes on the electorate pad 36. When the mobile device 1 is removed from the charging pad 36 the short range receiver circuit 39 will no longer receive the short range signal from the short range transmitter circuit 26 and thereupon the controller 40 will cut power to the electrode pad 36, i.e. the controller 40 is configured to depower the electrodes as a default.

In a variation of this embodiment, the signal from the shorter range transmitter circuit 26 includes information about the necessity of the battery 24 in the mobile device 1 to be charged. Thus, the short range signal could either indicate that the battery 24 in the mobile device 1 needs to be charged or the short range signal could indicate that the battery 24 in the mobile device 1 does not need to be charged. The controller 40 in the charging device 35 will upon receipt of such a signal indicating the need to be charged act accordingly and only power the electrodes of the charging pad 36 if the mobile device 1 that is placed on the charging pad 36 is compatible and needs to be charged. When the battery 24 has become sufficiently charged the processor 18 will instruct the short range transmitter circuit 26 to change the need for charging indication in the short range signal so that the controller 40 may cut the power to the electrodes on the electrode pad 36 when the battery 24 is charged.

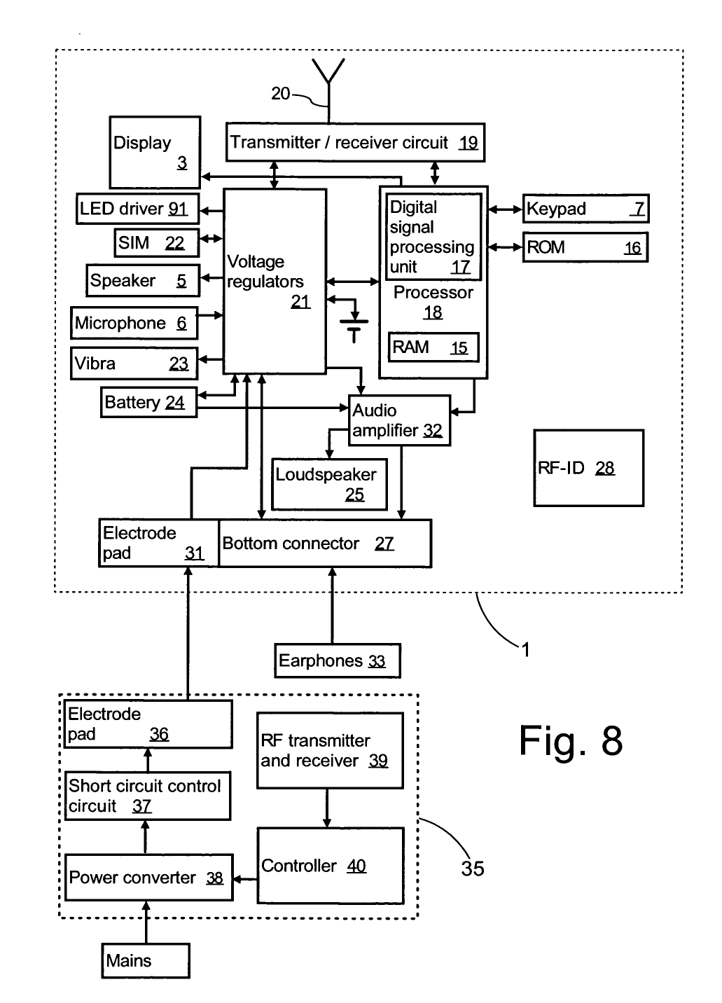

FIG. 8 illustrates another embodiment of the invention that is essentially identical with the embodiment of FIG. 7 except that the mobile device one is not provided with a short range transmitter circuit 26 that is connected to the processor 18. Instead, the mobile device one is provided with a near field RFID tag 28. Further, the charging device 35 is provided with an RF transmitter and receiver 39. When the mobile device 1 is placed on the charging pad 36 the RFID tag 28 is in close enough range for responding to a signal from the RF transmitter and receiver 39. The short range signal from the RF tag 28 will include information identifying the type of mobile device 1. The RF transmitter and receiver 39 will receive the responding signal from the RFID tag and thereby be able to identify the type of mobile device 1 and be able to establish whether the mobile device 1 is compatible with the charging device 35.

Although the compatibility establishment via a short range signal has been described in combination with the short-circuit protection system, it is understood that these aspects can be implemented in a charging device separately, i.e. the identification of the mobile device and eventual its need to be charged or not can be implemented in a charging device that does not have the short-circuit protection system. The same applies to the concept of determining the need of the mobile device to be charged and the identification (compatibility) aspect. Thus, it is possible to provide a charging device 35 that will only check if the short range signal indicates that the mobile device 1 has a need to be charged without doing any compatibility check.

The invention has numerous advantages. Different embodiments or implementations may yield one or more of the following advantages. It should be noted that this is not an exhaustive list and there may be other advantages which are not described herein. One advantage of the invention is that it allows for the charging pad to continue operation when a short-circuit occurs. It is another advantage of the invention that it allows to prevent an incompatible mobile device to be inadvertently and incorrectly charged by the charging device. Further, it is another advantage of the invention that it allows the electrodes of the charging device to be powered only when absolutely necessary, thereby saving energy.

The term “comprising” as used in the claims does not exclude other elements or steps. The term “a” or “an” as used in the claims does not exclude a plurality.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon. Moreover, it should be appreciated that those skilled in the art, upon consideration of the present disclosure, may make modifications and/or improvements on the apparatus hereof and yet remain within the scope and spirit hereof as set forth in the following claims.

1-20. (canceled)

21. A charging device comprising:
a plurality of electrodes on a charging surface for galvanic charging,
a wireless receiver or transceiver configured to receive a wireless signal from a mobile device to be charged,
a power source connected to said electrodes, and
a controller coupled to said wireless receiver and to said power source,
said controller being configured to control the power to said electrodes in response to a wireless signal received from said mobile device to be charged.

22. A charging device according to claim 21, wherein said controller is further configured to depower said electrodes as a default.

23. A charging device according to claim 21, wherein said controller is further configured to determine on the basis of the wireless signal if the mobile device is of a type that can be charged with the charging device.

24. A charging device according to claim 23, wherein said controller is further configured to power said electrodes whilst a wireless signal is received that is associated with a mobile device that can be charged with the charging device.

25. A charging device according to claim 24, wherein said controller is further configured to depower the electrodes when said wireless signal that is associated with a mobile device that can be charged with the charging device is no longer received.

26. A charging device according to claim 23, wherein the identification of the mobile device is realized with near field radio frequency identification.

27. A charging device according to claim 21, wherein said controller is configured to determine from the wireless signal received from the mobile device to the charger if the mobile device needs to be charged.

28. A charging device according to claim 27, wherein said controller is configured to power the electrodes whilst it receives a signal indicating that the mobile device needs to be charged.

29. A charging device according to claim 28, wherein said controller is configured to depower the electrodes when said signal indicating that the mobile device needs to be charged is no longer received.

30. A mobile electronic device powered by a rechargeable battery, said mobile device comprising:
a plurality of electrodes on a charging surface for galvanic charging;
a wireless transmitter or transponder;
a controller configured to instruct said transmitter or transponder to transmit a wireless signal indicating that the mobile electronic device requires charging when the controller has determined that said battery needs to be charged.

31. A mobile electronic device according to claim 30, further wherein:
said wireless transmitter or transponder is configured to transmit a signal indicating the compatibility of the mobile device with charging devices.

32. A mobile electronic device according to claim 30, wherein said transmitter or transponder is a short range device.

33. A charging device comprising:
a multitude of positive and negative electrodes on a charging surface,
a power source connected to said electrodes, and
said power source comprising a short circuit protection system configured to reduce electric power at any electrodes that are short circuited.

34. A charging device according to claim 33, wherein said the short circuit protection system comprises a positive thermal coefficient resistor connecting the power source and the positive electrodes.

35. A charging device according to claim 33, wherein said electrodes are arranged in an array on said charging surface.

36. A charging device according to claim 35, wherein said array is a matrix.

37. A charging device according to claim 35, wherein said array is a rectangular matrix with alternating positive and negative electrodes.

38. A charging device according to any of claims 33, wherein each of the positive electrodes is connected to said power source via positive temperature coefficient resistor.

39. A method for operating a charging device that comprises a multitude of electrodes on a charging surface, said method comprising:
powering the electrodes; and
reducing, by a short circuit protection system, power to the electrodes that are part of a short circuit.

40. A method according to claim 39, wherein the current to the positive contact electrodes that are the part of a short circuit is reduced by a positive thermal coefficient resistor.
